(19) United States
(12) Patent Application Publication
(10) Pub. No.: US 2011/0221285 A1
(43) Pub. Date: Sep. 15, 2011

(54) ROLLING BEARING HAVING INTEGRATED RELUCTANCE STEPPER MOTOR

(75) Inventor: Thomas Rink, Waldfenster (DE)

(73) Assignee: SCHAEFFLER TECHNOLOGIES GMBH & CO. KG, Herzogenaurach (DE)

(21) Appl. No.: 13/129,973

(22) PCT Filed: Nov. 6, 2009
(86) PCT No.: PCT/DE2009/001575

§ 371 Date: May 18, 2011

(30) Foreign Application Priority Data
Nov. 21, 2008 (DE) 10 2008 058 319.7

(51) Int. Cl. H02K 37/02

(52) U.S. Cl. 310/49.44

(57) ABSTRACT

A rolling bearing, which includes a first bearing ring, a second bearing ring, an intermediate element, which can be a rolling body, or a cage for a rolling body, arranged movably between both bearing rings, and a reluctance stepper motor, which has a rotor and a stator. The stator is formed by at least one pole shoe, which is arranged between the two bearing rings and has magnetic field that can be electrically controlled. The intermediate element is designed as a rotor of the reluctance stepper motor.

### FIELD OF THE INVENTION

The invention relates to a rolling bearing in accordance with the preamble of claim 1.

The requirement of preventing stoppage of the rolling bearings even when the shaft supported in the rolling bearing is subject to no load, specifically no torque, is known from practical operations with rolling bearings. This is because, if the stationary shaft is subject to a brief occurrence of torque, slip occurs in the stationary rolling bearing since the components of the rolling bearing, in particular the rolling contact elements and the bearing rings, are subject to very high acceleration relative to one another. The slip which occurs during the sudden acceleration of the rolling bearing leads to damage of the rolling bearing and significantly reduces the life thereof. As a countermeasure, provision can be made to provide the rolling bearing with a motor drive, which ensures relative motion between the two bearing rings of the rolling bearing, for example, even if there are no forces acting on the shaft supported in the rolling bearing, thus ensuring that the rolling bearing and hence also the shaft remain in motion. If forces involving a torque suddenly act on a moving shaft, the shaft is subject to less acceleration than a shaft which is accelerated from a standstill. Moreover, lower forces occur in the rolling bearing and the slip can be eliminated, thus ensuring that the rolling bearing has a longer life.

The situation described above occurs, for example, in the production of wire in rolling mills, in which a slab from which the wire is produced enters wire guiding rollers at high speed, the result being that the wire guiding rollers or the rolling bearings thereof are subject to high acceleration. The change in the speed of the rolling bearing of the wire guiding roller is particularly great if the slab enters a stationary wire guiding roller, leading to the occurrence of very high forces and severe slip in the rolling bearing of the wire guiding roller. If, however, the rotation of the wire guiding roller is maintained by the rolling bearing when no slab is being guided, and a slab enters the wire guiding roller, there is a smaller change in speed in the rolling bearing, which also has to absorb smaller forces.

The principle of the reluctance stepper motor is known from the prior art. Here, use is made of the fact that a moving magnetizable body arranges itself in a magnetic circuit in such a way as to minimize the magnetic resistance. More specifically, the magnetic body will align itself in a first magnetic field of a first pole shoe in such a way that it tends toward a position of equilibrium, in which the flux of the first magnetic field through the magnetic body is at a maximum. If a second magnetic field, adjacent to the first magnetic field, is provided and the magnetic body swings beyond the position of equilibrium relative to the first magnetic field, the magnetic body can enter the second magnetic field. Through an appropriate polarity of adjacent magnetic fields, the magnetic body can be made to travel, thus making it possible to construct a drive. More specifically, shafts can be made to rotate or the rotation thereof maintained if they are assigned a motor drive in the form of a reluctance stepper motor.

DE 103 59 856 A1 describes a three-phase reluctance stepper motor, the stator of which is arranged in a manner fixed in terms of rotation relative to a bearing holder and the rotor of which is arranged in a manner fixed in terms of rotation relative to a shaft. The stator and the rotor are each supported by means of two axially spaced rolling bearings, the respective outer rings of the two rolling bearings being arranged on the bearing holder and the respective inner rings of the rolling bearings being arranged on the shaft. The stator and the rotor of the reluctance stepper motor are arranged outside the two rolling bearings and in such a way as to be structurally separate from the bearing rings of the rolling bearings, with an axial extent of the reluctance stepper motor being significantly greater than the respective axial extent of one of the two rolling bearings. Moreover, the radial extent of the reluctance stepper motor is up to 1.3 times the radial extent of one of the two rolling bearings.

JP 2003309946 AA (Abstract) describes a rolling bearing designed as a needle bearing, having an outer ring designed as a first bearing ring and intermediate elements designed as needles, which roll directly on an outer circumferential surface of a shaft. The rolling bearing comprises a reluctance stepper motor having a rotor and a stator. In order to accommodate the stator, the outer ring is significantly extended in the axial direction, giving rise to a stator section, the axial extent of which is greater than the axial extent of the needles. The shaft is designed as the rotor, the outer circumferential surface of said shaft having, in an area situated opposite the stator section, an appropriate coating, the axial extent of which is greater than the axial extent of the needles. In order to form the reluctance stepper motor, the axial extent of the rolling bearing is significantly increased.

### OBJECT OF THE INVENTION

It is the object of the invention to specify a rolling bearing which has a reluctance stepper motor and which requires only slight structural modifications.

### SUMMARY OF THE INVENTION

According to the invention, this object is achieved in the rolling bearing mentioned at the outset by virtue of the fact that the stator is formed by at least one pole shoe, which is arranged between the two bearing rings and the magnetic field of which can be electrically controlled, and that the intermediate element is designed as the rotor of the reluctance stepper motor.

Arranging the at least one pole shoe between the two bearing rings requires no change in the outside dimensions of the rolling bearing, more particularly no extension of the rolling bearing in the axial direction. Since intermediate elements are present between the bearing rings in any case in a rolling bearing, no additional components designed as a rotor are required. In particular, the outside dimensions of the rolling bearing can remain unchanged.

Provision is preferably made for the at least one pole shoe to be arranged on a carrier ring, which is secured on one of the two bearing rings. By means of the carrier ring, the pole shoe or pole shoes can be retrofitted to and, when required, removed from already existing rolling bearings. More specifically, the carrier ring can comprise an annular elastic section which is fixed on one of the two bearing rings, in such a way, for example, that it is spring loaded into a groove in the inward-facing circumferential surface of said one of the two bearing rings and is either clamped firmly in said groove by the elastic pressure between the elastic section and the groove base or is fixed in the groove by means of further fixing means, if required as an additional measure. By means of the carrier ring, the pole shoes can be positioned correctly, more particularly reproducibly, relative to the intermediate elements.

The rolling contact elements can be provided as the intermediate elements designed as the rotor of the reluctance stepper motor, especially if the rolling contact elements are composed of a material which has a permeability that is significantly higher than the permeability of the surroundings of the rolling contact elements in the interior of the rolling bearing, e.g. a permeability that is significantly higher than the permeability of air or a vacuum. All the rolling contact elements or just some of a number of rolling contact elements can be provided as the rotor of the reluctance stepper motor; specifically for the case where all the rolling contact elements are made from a material, the permeability of which is only slightly greater than the permeability of the surroundings of the rolling contact element, provision can be made for some of the rolling contact elements to be replaced by other rolling contact elements, the permeability of which is significantly greater than that of the remaining rolling contact elements and than that of the surroundings of the rolling contact elements.

As an alternative or as a supplementary measure to the design of the rolling contact elements as the rotor of the reluctance stepper motor, provision can be made for the intermediate element to be a cage for rolling contact elements, and for a section or sections of the cage to have an area composed, in particular, of a soft-magnetic material. For example, it is possible for cages made of brass, which has a permeability approximately the same as the permeability of air, to be constructed as the rotor of the reluctance stepper motor by securing pre-cut parts made of soft-magnetic material, for example, on sections of the body of the brass cage, the pre-cut parts being arranged at separate locations on the body of the brass cage and having a shape such that the pre-cut parts project beyond the edge of the body of the brass cage to such an extent that the pre-cut parts come close to the pole shoes of the stator, in particular can be arranged between two opposite pole shoes of one pole shoe pair of the stator when the cage passes this pole shoe pair of the stator.

In another alternative to the design of the intermediate element as a rolling contact element or as a section, in particular a soft-magnetic section, of the cage for the rolling contact elements, provision can be made, as regards the design of the intermediate element, for the intermediate element to be designed as a loose distance piece composed, in particular, of a soft-magnetic material, which holds adjacent rolling contact elements apart.

Provision is preferably made for the at least two pole shoes to be arranged opposite one another in pairs on at least one of the two bearing rings, ensuring that a force which is symmetrical in relation to the race and acts in the circumferential direction of the bearing ring is exerted on the intermediate elements.

Provision is preferably made for the two bearing rings to be preloaded relative to one another, ensuring that the drive torque transmitted directly from the stator to the rotor can be transmitted to the other bearing ring, that which is not carrying the stator, and can also be passed indirectly to the supported shaft. The two bearing rings can already be preloaded relative to one another when installed; as an alternative, it is possible for the preload to arise only during the operation of the rolling bearing, when the rolling bearing is subject to loading.

Provision is preferably made for two or more pole shoes to be provided. However, it is likewise possible for the stator to be formed by a single pole shoe. This single pole shoe can be arranged on a bearing ring of the rolling bearing or on a carrier ring secured on the bearing ring, for example. The single pole shoe is controlled in such a way that it attracts a first rolling contact element as it approaches the single pole shoe and, when the first rolling contact element is passing the pole shoe, the magnetic field is switched off, ensuring that the first rolling contact element moves past the single pole shoe by virtue of its inertia. The single pole shoe is then once again controlled in such a way that it attracts a second rolling contact element following the first rolling contact element, until the second rolling contact element is passing the single pole shoe. In this way, it is possible to accelerate individual rolling contact elements by means of the single pole shoe. In this case, the closed magnetic circuit is formed by the bearing ring or carrier ring, the single pole shoe, the rolling contact element and the bearing ring or carrier ring. It is self-evident that, instead of accelerating individual rolling contact elements, the single pole shoe can also accelerate sections of the body of the cage which follow on from one another in the circumferential direction of the cage and can thus drive the cage as a whole.

Further advantages and features of the invention will emerge from the dependent claims and from the following description of a preferred illustrative embodiment of the invention.

The invention is described and explained in greater detail below with reference to the attached drawings.

### BRIEF DESCRIPTION OF THE DRAWINGS

FIG. 1 shows a schematic plan view of a bearing ring of a first illustrative embodiment of a rolling bearing according to the invention,

FIG. 2 shows a schematic cross-sectional view of a modification of the first illustrative embodiment shown in FIG. 1,

FIG. 3 shows a schematic cross-sectional view of a second illustrative embodiment of a rolling bearing according to the invention.

### DETAILED DESCRIPTION OF THE DRAWING

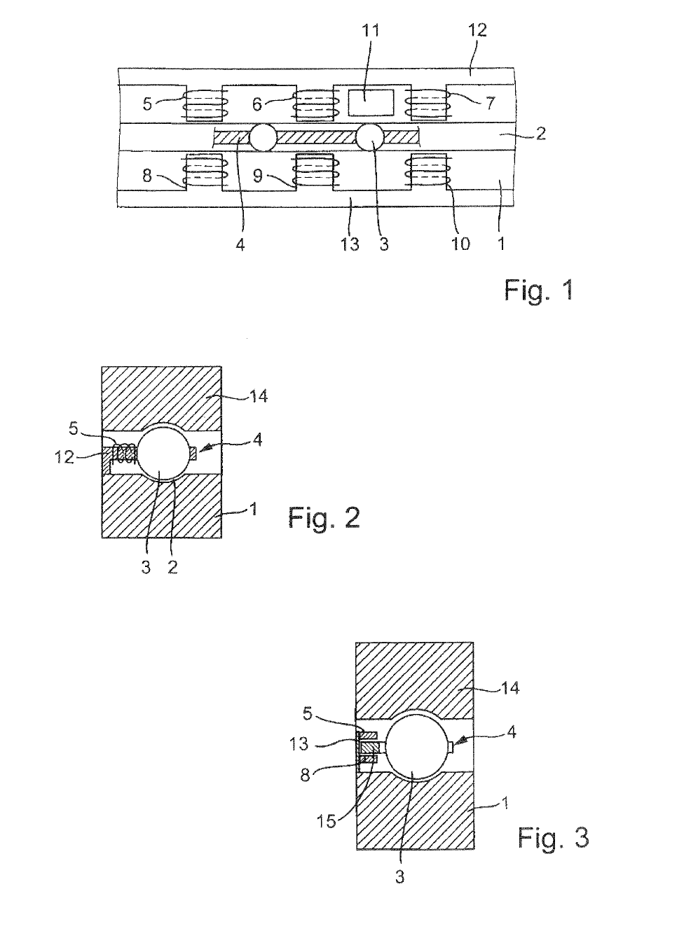

FIG. 1 shows a first bearing ring 1 of a rolling bearing, on the race 2 of which intermediate elements designed as rolling contact elements 3 roll, said intermediate elements holding the bearing ring 1 apart from a second bearing ring (not shown) and being capable of moving relative to both bearing rings. The rolling contact elements 3 are guided in a cage 4, only one section of which is shown.

A first pole shoe 5 and a second pole shoe 6, which is adjacent in the direction of motion of the rolling contact elements 3, and a further, third pole shoe 7 are arranged on the first bearing ring 1. Arranged on the first bearing ring opposite the first pole shoe 5 in relation to the race 2, is a fourth pole shoe 8, fifth pole shoe 9 being arranged opposite the second pole shoe 6 and a sixth pole shoe 10 being arranged opposite the third pole shoe 7. In this arrangement, the first pole shoe 5 and the fourth pole shoe 8 form a first pole shoe pair, the second pole shoe 6 and the fifth pole shoe 9 form a second pole shoe pair, and the third pole shoe 7 and the sixth pole shoe 10 form a third pole shoe pair. Each of the pole shoes 5, 6, 7, 8, 9, 10 comprises a yoke composed of an easily magnetizable material, e.g. a soft-magnetic material, and the yoke is in each case surrounded by a coil, through which there is a flow of current, the magnetic field of which is intensified by the material of the respective yoke. The magnetic field of the respective pole shoes 5, 6, 7, 8, 9, 10 extends into the area of the rolling contact elements 3 and, as a result, the rolling contact element 3 successively enters the area of the first pole shoe pair, then that of the second pole shoe pair and, finally, that of the third pole shoe pair.

Each of the rolling contact elements 3 is made of a material, the permeability of which is significantly higher than the permeability of the surroundings of the rolling contact element 3 and, more particularly, each of the rolling contact elements 3 is made of a soft-magnetic material, with the result that the rolling contact element 3 is magnetized in the magnetic field of each of the three pole shoe pairs, a magnetization which largely disappears as soon as the rolling contact element 3 is removed from the magnetic field of the pole shoe pair.

An electronic control device 11, which is arranged on the first bearing ring 1, supplies the coils of the pole shoes of the first pole shoe pair and the coils of the second pole shoe pair with current in such a way that the rolling contact element 3, which has aligned itself substantially centrally between the two pole shoes of the first pole shoe pair, namely the first pole shoe 5 and the fourth pole shoe 8, is pulled toward the second pole shoe pair, with the result that the rolling contact element 3 aligns itself substantially centrally between the second pole shoe 6 and the fifth pole shoe 9 of the second pole shoe pair. Between the two pole shoes of each pole shoe pair and the rolling contact element there is a closed magnetic circuit, within which the moving rolling contact element 3 arranges itself in such a way as to minimize magnetic resistance. If the magnetic circuit changes, e.g. in such a way that the adjacent pole shoe pair forms the magnetic circuit, the rolling contact element 3 aligns itself in such a way in this adjacent pole shoe pair that the magnetic resistance is once again minimized. However, such alignment in the adjacent pole shoe pair assumes that the rolling contact element 3 moves to the adjacent pole shoe pair. In effect, appropriate control of the pole shoe pairs leads to a substantially continuous movement of the rolling contact elements 3, during which the cage 4 is taken along. Here, the rolling contact element 3 is operated as the rotor of a reluctance stepper motor, the stator of which is formed by the pole shoes 5, 6, 7, 8, 9, 10, which are fixed on the bearing ring 1.

Pole shoes 5, 6, 7 are arranged on a first carrier ring 12, and pole shoes 8, 9, 10 are arranged on a second carrier ring 13, both carrier rings 12, 13 having sections composed of a spring-elastic material, by means of which the carrier rings 12, 13 are mounted on a groove (not shown specifically) in the bearing ring 1 and can be fixed in said groove. A seal groove, which is formed on the inner circumferential surface of the bearing ring 1 in order to accommodate a seal element, can be provided as a groove, for example. In particular, the carrier ring 12, 13 can be accommodated in a seal element and can be fixed on the bearing ring 1 by means of the seal element.

FIG. 2 shows a modified representation of the first illustrative embodiment, in which the first pole shoe 5 is provided on a first side of the race 4. There is no other pole shoe opposite the first pole shoe 5, and therefore no pole shoe pairs are formed. The rolling contact element 3 is accommodated in a cage 4, which is open on the side facing the pole shoe 5, ensuring that the material of the cage 4 does not interfere with the magnetic field of the first pole shoe 5. The first carrier ring 12 is of substantially angled design and is secured on the first bearing ring 1, close to the end face of the latter. The first bearing ring 1 is designed as the outer ring of the rolling bearing. A second bearing ring 14 is connected to a shaft (not shown in the diagram) for co-rotation therewith; however, it is self-evident that the second bearing ring 14 can be omitted, the rolling contact elements 3 thus rolling directly on the circumferential surface of the shaft. In this case, the circumferential surface of the shaft corresponds to the second bearing ring.

In the illustrative embodiment described above and shown in FIG. 1 and FIG. 2, the intermediate element of the rolling bearing was designed as a rolling contact element 3 and hence as the rotor of the reluctance stepper motor, the stator of the reluctance stepper motor comprising the pole shoes 5, 6, 7, 8, 9, 10.

FIG. 3 shows a rolling bearing having a first bearing ring 1, a second bearing ring 14 and an intermediate body, which is accommodated between the bearing rings 1, 14 in such a way that it can move relative to the two bearing rings 1, 14.

The cage 4 is designed as the intermediate body and hence as the rotor of the reluctance stepper motor, said cage guiding rolling contact elements 3, which are composed of a material that has only a low permeability and hence undergoes only slight magnetization in an applied magnetic field.

The body of the cage 4 is composed of a material, e.g. brass, which likewise has only a low permeability in comparison with air. To make the cage 4 more suitable as a rotor for the reluctance stepper motor, a pre-cut part 15 made of a soft-magnetic material is attached to the body of the cage 4. A plurality of pre-cut parts 15 are arranged on the outer circumferential surface of the body of the cage 4, being spaced apart in such a way that the pre-cut parts 15 project beyond the outline of the body, which is substantially circular in a plan view of the body.

The pre-cut parts 15 on the body of the cage 4 are arranged and dimensioned in such a way that they are accommodated between two pole shoes 5, 8 of a first pole shoe pair. Each of the two pole shoes 5, 8 is designed as a yoke, which is surrounded by a current-carrying coil, it being possible for the current in the coil to be switched on and off by a control device (not shown) or for the intensity of the current supplied to be subject to timing. A second pole shoe of a second pole shoe pair, which forms the stator of the reluctance stepper motor with further pole shoes, is not shown. The pole shoes 5, 8 and the further pole shoes are secured on a carrier ring 13, which is arranged on the first bearing ring 1.

In the two illustrative embodiments described above, the stator, comprising pole shoes 5, 6, 7, 8, 9, 10, and the intermediate element designed as the rotor, namely the rolling contact element 3 (FIGS. 1 and 2) or the cage (FIG. 3), were accommodated within the bearing, i.e. in the area between the inner circumferential surface of the outer ring and the outer circumferential surface of the inner ring of the rolling bearing. In both cases, it was important that the pole shoes 5, 6, 7, 8, 9, 10 be in spatial proximity to the race 2 of the rolling contact elements 3 to ensure a magnetic field of maximum strength from the pole shoes 5, 6, 7, 8, 9, 10 at this point. In the two illustrative embodiments described, the two rolling bearings were each standard rolling bearings, in which it was not necessary to make any structural modification to the bearing rings 1, 14 in order to accommodate the stator. In particular, the structural dimensions of the two rolling bearings remained unchanged.

In the text above, the invention was described with reference to an illustrative embodiment in which in each case one of two adjacent pole shoe pairs was supplied in order to make possible the movement of the intermediate element, specifically the rolling contact element 3 or the cage 4. Instead of such single-step operation for control of the pole shoes 5, 6, 7, 8, 9, 10, it is also possible to provide for joint control of two adjoining pole shoe pairs, especially when the intermediate body is situated centrally between the two pole shoe pairs on the race 2. Supplementing half-step operation of this kind with control in single-step operation gives full-step operation. In any case, the invention is independent of whether the intermediate elements designed as the rotor of the reluctance stepper motor is carried out in half-step, single-step or full-step operation or in some other operating mode of the pole shoes 5, 6, 7, 8, 9, 10.

In the illustrative embodiments described above, the rolling contact elements 3 or pre-cut parts 15 on the body of the cage 4 were composed of a soft-magnetic material, especially a soft-magnetic rolling bearing steel. It is self-evident that a hard-magnetic material can also be provided for the intermediate bodies, said material undergoing permanent residual magnetization by an applied magnetic field when the magnetic field is switched off. Intermediate elements composed of hard-magnetic material then undergo reversal of magnetization at the pole shoes 5, 6, 7 and 8, 9, 10 that follow one another in the direction of the race 2.

In the text above, the invention was described with reference to an illustrative embodiment in which the rolling contact elements 3 were guided in a cage 4. The invention is likewise provided for the case where the rolling contact elements 3 are not guided in a cage 4 but revolve on the race 2 in contact with one another. In this case, the pole shoes 5, 6, 7, 8, 9, 10 are preferably arranged at a distance from the pitch circle which the rolling contact elements 3 trace, i.e. at a lateral distance from the race, in a side view of the race 2, such that the end sections of the rolling contact elements 3 and gaps between the end sections of the adjacent rolling contact elements 3 are arranged in the region of the magnetic field of the pole shoes 5, 6, 7, 8, 9, 10, thus ensuring that as large as possible a change in the magnetic flux through the rolling contact elements is achieved.

In the text above, the invention was described with reference to an illustrative embodiment in which the rolling contact elements 3 and the cage 4 together with the pre-cut parts 15 were the only intermediate elements in the rolling bearing. It is self-evident that loose distance pieces which are arranged between rolling contact elements 3, in particular adjacent rolling contact elements 3, and which hold the rolling contact elements 3 apart can also be provided as the rotor of the reluctance stepper motor.

In the illustrative embodiments described above, the material of the rolling contact elements 3 and of the pre-cut parts 15 on the body of the cage 4 was in each case a soft-magnetic material. It is self-evident that the material can also be a ceramic with a high permeability in comparison with air.

In the first illustrative embodiment (FIG. 1 and FIG. 2) described above, all of the rolling contact elements 3 were designed to form the rotor of the reluctance stepper motor. It is self-evident that just one or just some of the rolling contact elements 3 can be designed to form the rotor of the reluctance stepper motor and, in particular, it is possible for just one of the rolling contact elements to be composed of a soft-magnetic material.

In the second illustrative embodiment described above, the cage 4 was provided in sections with pre-cut parts 15 composed of a soft-magnetic material in order to construct the brass cage 4 as the rotor of the reluctance stepper motor. It is self-evident that, in the case of a cage or a rolling contact element which is composed of a nonmagnetic but magnetizable material, a magnetic field can be imposed, if appropriate in a section or sections, on the body of the rolling contact element, of the cage or of a general intermediate element, thus making it possible to dispense with an additional component such as the pre-cut part 15 on the cage 4 and ensuring that the cage 4 retains its original form.

In the illustrative embodiments described above, the pole shoes 5, 6, 7, 8, 9, 10 were each designed as yokes surrounded by coils. It is self-evident that other designs of pole shoe can be provided.

List of Reference Signs

| | |
|---|---|
| 1 | First Bearing Ring |
| 2 | Race |
| 3 | Rolling Contact Element |
| 4 | Cage |
| 5 | First Pole Shoe |
| 6 | Second Pole Shoe |
| 7 | Third Pole Shoe |
| 8 | Fourth Pole Shoe |
| 9 | Fifth Pole Shoe |
| 10 | Sixth Pole Shoe |
| 11 | Electronic Control Device |
| 12 | First Carrier Ring |
| 13 | Second Carrier Ring |
| 14 | Second Bearing Ring |

1-7. (canceled)

8. A rolling bearing, comprising
a first bearing ring;
a second bearing ring;
an intermediate element, which acts as a rotor, arranged between the bearing rings in such a way that the intermediate element can move relative to both of the bearing rings; and
at least one pole shoe, which forms a stator, arranged between the bearing rings and having a magnetic field of which can be electrically controlled,
wherein the rotor and the stator and the form a reluctance stepper motor.

9. The rolling bearing as claimed in claim 8, further comprising a carrier ring secured on one of the bearing rings with the at least one pole shoe is arranged on the carrier ring.

10. The rolling bearing as claimed in claim 8, wherein at least two pole shoes are arranged opposite one another in pairs on at least one of the bearing rings.

11. The rolling bearing as claimed claim 8, wherein the intermediate element is a rolling contact element.

12. The rolling bearing as claimed claim 11, wherein the rolling contact element composed of a soft-magnetic material.

13. The rolling bearing as claimed in claim 8, wherein the intermediate element is a cage for rolling contact elements, and the cage has a section or sections that has or have an area composed a soft-magnetic material.

14. The rolling bearing as claimed in claim 8, wherein the intermediate element is a loose distance piece comprised of a soft-magnetic material, which holds adjacent rolling contact elements apart from each other.

15. The rolling bearing as claimed in claim 8, wherein the bearing rings are preloaded relative to one another.
